(19) United States
(12) Patent Application Publication
(10) Pub. No.: US 2017/0046309 A1
(43) Pub. Date: Feb. 16, 2017

(54) METHOD FOR PROVIDING RELIABLE SENSOR DATA

(71) Applicant: SIEMENS AKTIENGESELLSCHAFT, MÜNCHEN (DE)

(72) Inventors: Thomas Hubauer, Garching bei München (DE); Steffen Lamparter, Feldkirchen (DE); Mikhail Roshchin, München (DE); Nina Solomakhina, Riemerling (DE); Stuart Watson, Newark (GB)

(73) Assignee: SIEMENS AKTIENGESELLSCHAFT, MÜNCHEN (DE)

(21) Appl. No.: 15/303,480

(22) PCT Filed: Feb. 27, 2015
(86) PCT No.: PCT/EP2015/054121

§ 371 Date: Oct. 11, 2016

(30) Foreign Application Priority Data
Apr. 29, 2014 (DE) 10 2014 208 034.7

(51) Int. Cl. G06F 17/18; G06F 17/50; G01D 21/00; G05B 23/02

(52) U.S. Cl. CPC G06F 17/18; G05B 23/0221; G06F 17/5009; G01D 21/00; G05B 2219/34416; G06F 2217/16

(57) ABSTRACT

A method for making reliable sensor data available and a device for making reliable sensor data of a system available is provided, including the following steps: receiving sensor data from at least one sensor unit that monitors a system component of the system, and processing the received sensor data using at least one stored ontology and a statistical data analysis model for generating the reliable sensor data.

### CROSS-REFERENCE TO RELATED APPLICATIONS

This application claims priority to PCT Application No. PCT/EP2015/054121, having a filing date of Feb. 27, 2015, based off of German application No. DE 102014208034.7 having a filing date of Apr. 29, 2014, the entire contents of which are hereby incorporated by reference.

### FIELD OF TECHNOLOGY

Modern industrial systems have an increasing complexity. In order to detect operating states and possible faults in such a system, it is necessary to automatically process data. Industrial installations may contain a multiplicity of sensor units which monitor different parameters, for example temperature, movement, vibration, pressure and the like. Sensor units are also themselves complex technical devices, that is to say the sensor units may in turn fail and/or the sensor data provided by them may be unreliable or incorrect. Potentially incorrect data comprise values or sensor values which are within a defined range but differ greatly from preceding and/or subsequent values. Further possibly incorrect data comprise sensor values which are outside a defined range and, in particular, exceed or undershoot predefined threshold values. Further possible incorrect data comprise recognizably missing data or unrecognizably missing data superimposed with noise, and oscillating or fluctuating data values.

### BACKGROUND

Such low-quality data make it difficult to estimate the system and process status of the system and to control or regulate the system behavior. This adversely affects the reliability of the system and at least partially voids analysis results.

### SUMMARY

An aspect relates to providing a method and an apparatus for increasing the quality of sensor data.

Embodiments of the invention therefore provide a method for providing reliable sensor data relating to a system, having the steps of:
receiving sensor data from at least one sensor unit which monitors a system component of the system, and
processing the received sensor data using at least one stored ontology and a statistical data analysis model in order to generate the reliable sensor data.

In one possible embodiment of the method according to the invention, the ontology has a system ontology of the system and/or a sensor ontology of the sensor units.

In another possible embodiment of the method according to the invention, various sensor units are grouped to form a sensor cluster on the basis of the system ontology and/or the sensor ontology of the system.

In one preferred embodiment of the method according to the invention, sensor units which are adjacent and/or similar to one another inside the system are grouped to form a sensor cluster.

In another possible embodiment of the method according to the invention, sensor data received from sensor units in the same sensor cluster are evaluated by means of the statistical data analysis model in order to determine correlations between the sensor data from the sensor units in the sensor cluster.

In another possible embodiment of the method according to the invention, unreliable sensor units inside the sensor cluster are detected on the basis of the determined correlations between sensor data from the various sensor units in the same sensor cluster and their sensor data are at least partially filtered out.

In another possible embodiment of the method according to the invention, the sensor units each provide stationary time series data.

In another possible embodiment of the method according to the invention, the sensor units each provide non-stationary time series data.

In another possible embodiment of the method according to the invention, the system ontology indicates an internal hierarchical structure of the system components contained in the system.

In another possible embodiment of the method according to the invention, the sensor ontology classifies the sensor units in different sensor classes.

In another possible embodiment of the method according to the invention, the sensor units themselves form system components of the system and/or are formed by external sensor units which monitor system components of the system.

In another possible embodiment of the method according to the invention, the sensor data received from the sensor units are additionally processed using a diagnosis ontology in order to generate the reliable sensor data.

In another possible embodiment of the method according to the invention, the system ontology of the system, the sensor ontology of the sensor units and the diagnosis ontology are linked to form an integrated ontology of the application.

In another possible embodiment of the method according to the invention, the statistical data analysis model is formed by a univariate data analysis model.

In an alternative embodiment of the method according to the invention, the statistical data analysis model is formed by a multivariate data analysis model.

Embodiments of the invention also provide a system having the features stated in patent claim 13.

Embodiments of the invention therefore provide a system having a multiplicity of system components which are monitored by sensor units which provide sensor data, and a data processing unit which processes the received sensor data using a stored ontology and a statistical data analysis model in order to generate reliable sensor data.

In one possible embodiment of the system according to the invention, the system is a machine having a multiplicity of machine components.

In one possible embodiment of the system according to the invention, the system is a turbine, in particular a gas turbine, having a multiplicity of machine components.

Embodiments of the invention also provide a data processing unit for preprocessing sensor data having the features stated in patent claim 15.

Embodiments of the invention therefore provide a data processing unit for preprocessing sensor data which come from sensor units which monitor system components of a system, in particular a machine, the data processing unit processing the received sensor data using at least one stored ontology and a statistical data analysis model in order to generate reliable sensor data.

### BRIEF DESCRIPTION

Some of the embodiments will be described in detail, with reference to the following figures, wherein like designations denote like members, wherein:

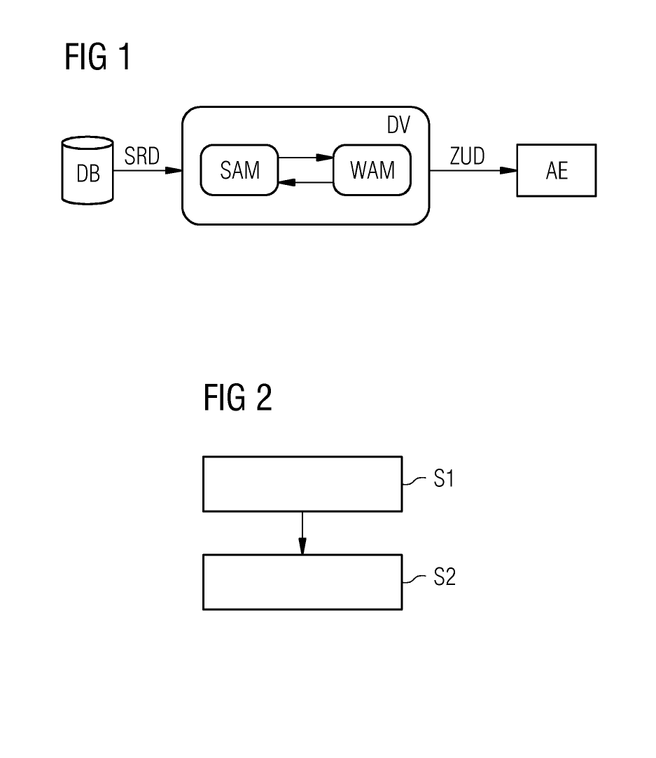

FIG. 1 shows a diagram for explaining the system according to embodiments of the invention;

FIG. 2 shows a flowchart for illustrating an exemplary embodiment of the method for providing reliable sensor data;

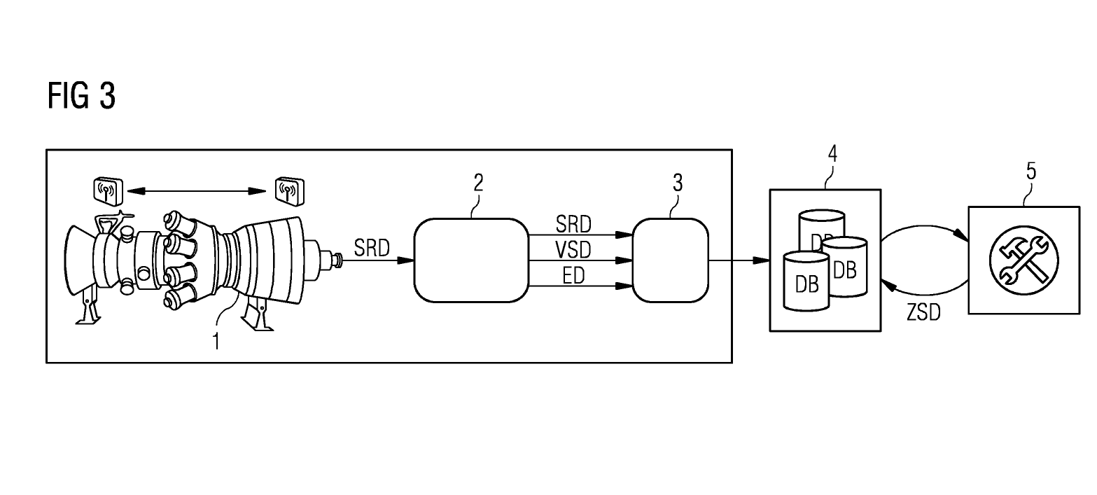

FIG. 3 shows an exemplary use for explaining the method according to embodiments of the invention and the system according to embodiments of the invention;

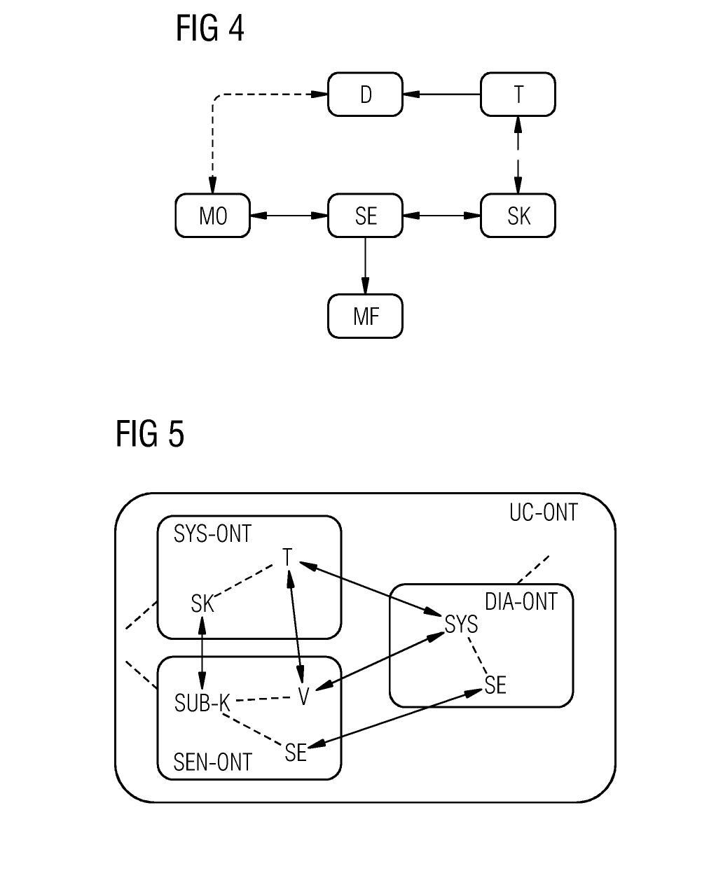

FIG. 4 shows a diagram for illustrating an exemplary ontology as can be used in the system illustrated in FIG. 3; and

FIG. 5 shows a diagram for illustrating an exemplary integrated ontology as can be used in the system illustrated in FIG. 3.

### DETAILED DESCRIPTION

FIG. 1 schematically shows the interaction of various units in the method according to embodiments of the invention for providing reliable sensor data relating to a system, in particular an industrial system 1. In the approach according to embodiments of the invention, statistical and knowledge-based methods are combined in order to improve the acquisition and correction of sensor data. The sensor data form a database DB from which sensor data, in particular sensor raw data SRD, can be read. A data processing unit DV uses statistical analysis components SAM and knowledge-based components WAM to generate reliable data ZVD and corrected data from the received data, in particular sensor data, which reliable data and corrected data can be used for further analysis and diagnostic steps in a further analysis unit AE. FIG. 1 shows a statistical analysis module SAM and a knowledge-based analysis module WAM which interact with one another and support one another in order to increase the quality of the received data, in particular sensor data. The statistical analysis module SAM and the knowledge-based analysis module WAM support one another in order to detect false-positive data received from the other module and to identify false-negative data not received from the other module. The statistical analysis module SAM uses at least one statistical data analysis model. The knowledge-based analysis module WAM uses at least one stored ontology ONT. The knowledge-based analysis module WAM preferably uses a system ontology SYS-ONT of the respective technical system 1, for example a turbine system, and a sensor ontology SEN-ONT of the sensor units SE which provide the received sensor data. The system ontology SYS-ONT of the industrial system 1, which has a multiplicity of sensor units SE each monitoring one or more system components SK of the system, preferably indicates an internal hierarchical structure of the system components contained in the system. The sensor units SE which provide the sensor data are themselves system components of the system in one possible embodiment. Alternatively, the sensor units SE can be at least partially formed by external sensor units which monitor system components of the system. The sensor units SE may each provide stationary or non-stationary time series data which are processed.

In one possible embodiment, various sensor units are grouped to form a sensor cluster SC on the basis of the system ontology SYS-ONT of the industrial system 1 and/or the sensor ontology SEN-ONT of the sensor units monitoring the industrial system 1. In one possible embodiment, sensor units which are adjacent or are positioned to be adjacent inside the industrial system 1 are grouped to form a sensor cluster SC. In another possible embodiment, various sensor units SE which monitor the same system component of the industrial system 1 at least with regard to a parameter to be monitored are grouped to form a sensor cluster SC. In another possible embodiment, sensor units which are similar to one another or sensor units of the same type are grouped to form a sensor cluster SC. In one possible embodiment, the sensor units SE are grouped to form a sensor cluster SC on the basis of predefined grouping criteria which must be satisfied alternatively or accumulatively.

Sensor data which are received from sensor units SE in the same sensor cluster SC are evaluated in one possible embodiment by means of a statistical data analysis model in order to determine correlations between the sensor data from the sensor units in the respective sensor cluster SC. Unreliable sensor units SE inside the sensor cluster SC are detected on the basis of the determined correlations between sensor data from the various sensor units SE in the same sensor cluster SC and their sensor data, in particular sensor raw data SRD, are preferably at least partially filtered out.

In one possible embodiment, information relating to the measured quality and/or the installation location of the sensor units SE is used to automatically identify those sensor units which can be used to replace other sensor units; that is to say, those sensor units which monitor the same parameter or the same measurement variable or a comparable measurement variable which can be derived therefrom or which provide corresponding sensor data and are situated in the immediate vicinity of the other sensor unit inside the industrial system 1 are automatically identified. The statistical analysis module SAM can provide methods for time series analysis which detects or identifies, for example, a trend or periodically occurring or seasonal effects of the received sensor data. Furthermore, the statistical analysis module SAM can provide methods for time series data analysis which allow fluctuating or oscillating data, noise and/or gaps in the received data to be detected. Furthermore, the statistical analysis module SAM can provide methods which determine a development of the correlation between sensor data provided by sensor units inside the copied sensor cluster.

FIG. 2 shows a flowchart for illustrating an exemplary embodiment of the method according to the invention for providing reliable sensor data relating to a system 1, in particular an industrial system.

In a first step S1, sensor data are received from at least one sensor unit SE, the sensor unit monitoring one or possibly more system components of the industrial system 1. In this case, the sensor unit either itself forms a system component of the system or is formed by an external sensor unit which monitors a system component SK of the industrial system 1.

In a further step S2, the received sensor data are processed using at least one stored ontology ONT and a statistical data analysis model in order to generate the reliable sensor data. The received sensor data or sensor raw data SRD are preferably processed in step S2 in real time. The statistical data analysis model used in step S2 is formed by a univariate or multivariate data analysis model. One or more ontologies can be used in step S2. An ontology SYS-ONT of the industrial system 1 and an ontology SEN-ONT of the sensor units SE used can preferably be used in step S2. Various sensor units are preferably grouped to form different sensor clusters SC on the basis of the system ontology SYS-ONT of the industrial system 1 and the sensor ontology SEN-ONT of the monitoring sensor units. Sensor data which come from sensor units in the same sensor cluster SC are evaluated by means of the statistical data analysis model SAM in order to determine correlations between the sensor data from the sensor units in the respective sensor cluster. It is possible to detect presumably unreliable sensor units SE inside the sensor cluster SC with the aid of the determined correlations and to at least partially filter out sensor data which come from such sensor units SE which are possibly classified as unreliable.

FIG. 3 shows an exemplary use for explaining the method of operation of the method according to embodiments of the invention and of the apparatus according to embodiments of the invention for providing reliable sensor data relating to an industrial system. In the exemplary use illustrated in FIG. 3, the industrial system 1 being monitored is a turbine, in particular a gas turbine. Such a turbine consists of a multiplicity of system components SK which may in turn consist of a multiplicity of system components. As main parts, a gas turbine has a compressor, a combustion chamber and a generator. The compressor accelerates a gas flowing in and increases its pressure by reducing the gas volume. The gas is heated at a constant pressure in the combustion chamber. The generator finally generates the power from the emerging hot gas.

The turbine 1 illustrated in FIG. 3 is an industrial system or an industrial installation having a multiplicity of system components. Many of the system components contained in the system 1 are monitored by measuring devices or sensor units SE. In this case, most sensor units themselves form system components of the industrial system 1. A multiplicity of sensor units provide sensor raw data SRD to a control unit 2 in which so-called soft sensors can be defined. In one possible embodiment, this control unit 2 can forward the sensor raw data SRD to a data collector 3. Furthermore, the control unit 2 can preprocess the received sensor raw data SRD and can provide the data collector 3 with the preprocessed sensor data VSD. Furthermore, the control unit 2 can preprocess and at least partially evaluate the received sensor raw data SRD in order to notify the data collector 3 of events, which have occurred in the industrial system 1, as event data ES. In one possible embodiment, the data collector 3 is connected, via a data network, to a data center 4 having databases DB to which the received data, in particular forwarded sensor raw data SRD, are written. A service center or a data processing unit 5 can then read the data stored in the databases DB of the data center 4 and can calculate reliable sensor data ZSD therefrom, which reliable sensor data are written back to a database DB of the data center 4.

In one possible embodiment, the method according to the invention for providing reliable sensor data relating to the industrial system 1 is carried out by the service center 5 illustrated in FIG. 3. Alternatively, the method according to embodiments of the invention can also be carried out by other units, in particular data processing units, which are situated at another location, for example in the control unit 2 or the data collector 3. In the case of time-critical data which require a fast response, the data processing of the sensor raw data SRD is carried out as close as possible to the industrial system 1 to be monitored in order to minimize time delays when responding to suspicious sensor data. Conversely, if the received sensor raw data SRD are less time-critical, the data processing or preprocessing of the sensor raw data SRD to form reliable sensor data can be carried out further away, for example by a data processing unit of the service center 5. The corrected or more reliable sensor data ZSD provided by the method according to embodiments of the invention can be processed further in order to generate control signals in response to the reliable sensor data. For example, a sensor unit SE inside a sensor cluster SC which probably operates unreliably can be deliberately switched off by means of control signals. Furthermore, it is possible to change over from a sensor unit which has possibly failed to a replacement sensor unit, for example. By virtue of the fact that the sensor data which are provided by replacement sensor units and/or adjacent sensor units are concomitantly taken into account, suspicious abnormal behavior of a sensor unit SE can be detected. In this case, it is possible to distinguish whether the suspicious sensor data are caused on account of abnormal behavior of the system component being monitored or by a faulty state of the monitoring sensor unit.

The sensor units can record a parameter, for example a temperature, pressure or another physical variable, with a particular frequency or period, in which case they provide time series data. These time series data may form discrete time series data or continuous time series data. In the case of discrete time series data, measurement observations are carried out at particular intervals of time and form a discrete data record. In the case of continuous time series, the measurement observations are continuously recorded over time. The time series are stationary if parameters, for example an average value or a standard deviation, do not change over time and do not follow a trend. Furthermore, the time series data may also be non-stationary.

FIG. 4 schematically shows an ontology which can be used in the method according to embodiments of the invention at a high level. A turbine T as an industrial system consists of system components SK. Sensor units SE are mounted on system components SK and have measurement capabilities MF. The sensor units SE provide observations or measurement observations MO which can be diagnosed or evaluated by a diagnostic unit D of the turbine T.

FIG. 5 shows, by way of example, the integration of different ontologies to form an overall ontology of the respective application. The application or use case UC comprises a plurality of ontologies which are integrated with one another, in particular a system ontology SYS-ONT of a technical system, for example a turbine T which consists of system components SK which in turn consist of subcomponents SUB-K, a sensor ontology SEN-ONT of an apparatus V having sensor units SE which in turn consist of subcomponents SUB-K, and a diagnosis ontology DIA-ONT which extends the system ontology SYS-ONT and the sensor ontology SEN-ONT. Equivalent classes between the various ontologies are illustrated in FIG. 5 using a solid double-headed arrow. Object properties are illustrated using dashed lines. In the example illustrated in FIG. 5, the integrated application ontology UC-ONT consists of three ontology modules linked to one another. The number of linked ontologies can vary depending on the application. The ontologies used can be implemented in different ontology languages. In one possible embodiment, the ontologies are implemented in the ontology language OWL 2 QL.

In one possible embodiment of the method according to the invention, sensor units SE are grouped to form sensor clusters with the aid of the ontologies.

A calculation rule for identifying sensor clusters is stated in meta-language below:

```
Input: Sensor labels
Output: Groups of duplicates for sensors
1 foreach sensor1 in sensor-list do
2 | foreach sensor2 in Ontology do
3 | | if SameType (sensor1, sensor2) AND SameAppliance
              (sensor1, sensor2)
  | | AND SameLocation (sensor1, sensor2) then
4 | | | DuplicatesList (sensor1) ← Add (sensor2)
5  end
6  end
7 end
```

The sensor data are statistically analyzed. A possible algorithm is stated in meta-notation below:

| Input: Sensor measurements | |
|---|---|
| Output: Summary of analysis for anomalies, corrected data | |
| 1 begin Missing data detection and prediction block | |
| 2 \| CheckForMissingValues( ); | |
| 3 \| if there is data missing then | |
| \| \| // | if too much data is lost, percentage is set in |
| \| \| | parameter threshold, reject the data |
| 4 \| \| \| if missing-data.size( ) > threshold then | |
| 5 \| \| \| | reject data; |
| 6 end | |
| 7 else RunPredictionalAlgorithm (missing-data); | |
| 8 end | |
| 9 end | |
| 10 CalculateAutocorrelation ( ); | |
| 11 if act-values < threshold then | |
| // | if autocorrelation is questionably low, look for |
| | oscillations |

12 CheckForOscillations ( )
13 end
14 CheckForOutliers ( );
15 CleanData;

Sensor data can be preprocessed on the basis of the sensor cluster information. A possible algorithm for integrating sensor cluster information is stated in meta-notation below:

Input: Sensor anomalies
Output: Sensor anomalies with excluded false positives, corrected data
1 CalculateCorrelation (sensor-list)
2 foreach sensor in sensor-list do
3 | if outlier-list not empty AND DuplicatesList (sensor) not empty
then
4 | | foreach outlier in outlier-list do
5 | | | | if at least one DuplicatesList has outlier then
6 outlier is a False Positive
7 end
8 end
9 end
10 CleanData ( );
11 end

In the method according to embodiments of the invention, statistical data analysis methods and domain information expressed in a formal model, in particular in an ontology ONT, are combined in order to provide an integrated data quality assessment of the received sensor data and their preprocessing to form reliable sensor data with increased data quality. In one possible embodiment, time series analysis methods, for example the ARIMA model and Kalman filters, are used. The method according to embodiments of the invention is suitable for different technical systems which are monitored by a multiplicity of sensor units SE. The method according to embodiments of the invention considerably increases the quality of the sensor data provided by the sensor units SE, with the result that the probability of the monitored system 1 failing is noticeably reduced. In addition, the method according to embodiments of the invention can be easily adapted to changes in the industrial system 1 to be monitored. If the composition of an industrial installation is changed, for example, this is easily taken into account by accordingly adapting the associated system ontology SYS-ONT of the system 1. Therefore, the method according to embodiments of the invention is flexible with respect to changes in the industrial system 1 to be monitored. In addition, the method according to embodiments of the invention takes into account whether the sensor units SE themselves are technical devices which consist of subcomponents. With the aid of the system ontology SYS-ONT and the sensor ontology SEN-ONT, it is also possible to take into account relationships between the sensor units, in particular their spatial relationship inside the technical system. The sensor ontology SEN-ONT can classify the sensor units SE in different sensor classes.

The system ontology SYS-ONT describes the internal structure of the industrial system 1 and can indicate, for example, all system components, parts, functional units and their hierarchy. The sensor ontology SEN-ONT can categorize different types of measuring units or sensor units which monitor the industrial system 1. For example, a main class may list all types of measuring units or sensor units mounted on the system 1 to be monitored. Descriptions of the sensor ontology may relate to different classes of sensor units and may provide further characteristic information relating to these sensor units. For example, a temperature sensor can monitor various measurement variables, for example the burner temperature, the inlet temperature or the compressor outlet temperature. Comparable or replacement sensor units can be identified by using the location of the sensor unit, its type and sensor characteristics or measurement properties or other information from the sensor ontology SEN-ONT. In addition, sensor units can be grouped to form sensor clusters on the basis of sensor features or criteria. The method according to embodiments of the invention makes it possible to preprocess sensor raw data SRD, with the result that sensor data with a high reliability or higher quality are generated. Furthermore, incorrect sensor data can be filtered out or missing sensor data can be detected. In addition, noisy sensor data or oscillating sensor data can be corrected.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for providing reliable sensor data relating to a system, comprising:
(a) receiving sensor data from at least one sensor unit which monitors a system component of the system; and
(b) processing the received sensor data using at least one stored ontology and a statistical data analysis model to generate the reliable sensor data.

2. The method as claimed in claim 1, the at least one stored ontology having a system ontology of the system and/or a sensor ontology of the at least one sensor unit.

3. The method as claimed in claim 2, further comprising a plurality of various sensor units that are adjacent and/or similar to one another inside the system, being grouped to form a sensor cluster on a basis of the system ontology and/or the sensor ontology of the system.

4. The method as claimed in claim 3, wherein the sensor data received from plurality of various sensor units in the same sensor cluster being evaluated by means of the statistical data analysis model in order to determine correlations between the sensor data from the plurality of various sensor units in the sensor cluster.

5. The method as claimed in claim 4, wherein unreliable sensor units inside the sensor cluster being detected on the basis of the determined correlations between sensor data from the plurality of various sensor units in the same sensor cluster and their sensor data being at least partially filtered out.

6. The method as claimed in claim 1, wherein the at least one sensor unit provides stationary and/or non-stationary time series data.

7. The method as claimed in 2, wherein the system ontology indicates an internal hierarchical structure of the system components contained in the system.

8. The method as claimed in claim 2, wherein the sensor ontology classifies the at least one sensor unit in different sensor classes.

9. The method as claimed in claim 1, wherein the at least one sensor unit forming system components of the system and/or is formed by an external sensor unite which monitor system components of the system from the outside.

10. The method as claimed in claim 2, wherein the sensor data received from the at least one sensor unit additionally is processed using a diagnosis ontology to generate the reliable sensor data.

11. The method as claimed in claim 10, wherein the system ontology of the system, the sensor ontology of the sensor units and the diagnosis ontology are linked to form an integrated ontology.

12. The method as claimed in claim 1, wherein the statistical data analysis model being formed by a univariate or multivariate data analysis model.

13. A system comprising:
a multiplicity of system components which are monitored by a plurality of sensor units which provide sensor data; and
a data processing unit which processes the received sensor data using at least one stored ontology and a statistical data analysis model to generate reliable sensor data.

14. The system as claimed in claim 13, wherein the system is a turbine, having a multiplicity of machine components.

15. A data processing unit for preprocessing sensor data which come from a plurality of sensor units that monitor a plurality of system components of a system, the data processing unit processing the received sensor data using at least one stored ontology and a statistical data analysis model to generate reliable sensor data.
